(19) United States
(12) Patent Application Publication
(10) Pub. No.: US 2024/0025736 A1
(43) Pub. Date: Jan. 25, 2024

(54) HYDROGEN PRODUCTION METHOD AND DEVICE

(71) Applicant: INSTYTUT NISKICH TEMPERATUR I BADAN STRUKTURALNYCH PAN IM.W.TRZEBIATOWSKIEGO, Wroclaw (PL)

(72) Inventors: Wieslaw STREK, Bielany Wroclawskie (PL); Przemyslaw WIEWIORSKI, Wroclaw (PL); Robert TOMALA, Wroclaw (PL); Wlodzimierz MISTA, Wroclaw (PL); Pawel GLUCHOWSKI, Wroclaw (PL)

(21) Appl. No.: 18/254,940

(22) PCT Filed: Nov. 19, 2021
(86) PCT No.: PCT/PL2021/050080

§ 371 Date: May 30, 2023

(30) Foreign Application Priority Data
Dec. 2, 2020 (PL) P.436197

(51) Int. Cl. C01B 3/06; B01J 8/16; B01J 19/10; B01J 19/12

(52) U.S. Cl. CPC C01B 3/06; B01J 8/16; B01J 19/10; B01J 19/123; B01J 19/128; B01J 19/127; B01J 2219/00486; B01J 2208/00805; B01J 2219/00819; B01J 2219/0877; B01J 2219/00936; B01J 2219/00943; B01J 2219/00945; C01B 2203/1205

(57) ABSTRACT

The invention relates to a method for producing hydrogen in a liquid and to a device for implementing the method characterized in that suspension 1.2 of graphene particles in the liquid is provided to reaction tank 1.1, and then the contents of the reaction tank are exposed to an electromagnetic radiation beam with a wavelength in the UV-VIS-FIR light wave range, which radiation is generated by emitter 1.5, after which the hydrogen liberated from the liquid is transferred through vent 7 outside the reaction tank.

### FIELD OF THE INVENTION

The present invention relates to a hydrogen production method and device, and more specifically to a method for producing hydrogen from a graphene-containing liquid and a device for implementing the method.

### BACKGROUND OF THE INVENTION

Hydrogen and oxygen production by water electrolysis is known in the state of the art. For example, PL203716 discloses that a device for producing hydrogen and oxygen by water electrolysis comprises a hydrolyzer in the form of a closed vessel separated tightly in an upper portion into two chambers, an oxygen and a hydrogen one, with an impermeable vertical plate not reaching the bottom of the hydrolyzer, having a bottom water-filled connection of the oxygen and hydrogen chambers, with electrodes separately supplied with power enclosed in the oxygen and hydrogen chambers and, among other things, four solenoid valves responsible for the process of discharging the oxygen and hydrogen produced from the hydrolyzer and maintaining pressure up to a suitable value in the tank. Water supplied to the tank must be purified beforehand (to be without chlorine, iron, impurities) and have a temperature of 15° C.

Therefore, there is a need to develop a new hydrogen production method, while omitting the hydrolysis step, and providing the possibility to produce hydrogen in devices that could be used in fuel cells.

In the course of research and development work, the Inventors developed a method and device for contactless and electrodeless production of hydrogen in a hermetic container with the possibility to recover it by transferring it to a separate container, to a fuel cell, or being integrated with another device that uses hydrogen.

### SUMMARY OF THE INVENTION

The method for producing hydrogen in a liquid according to the invention is characterized in that suspension 2 of graphene particles in the liquid is provided to reaction tank 1.1 made of transparent material partially or completely transmittable for the UV-VIS-FIR light wave range, and then the contents of reaction tank 1.1 are exposed to an electromagnetic radiation beam with a wavelength in the UV-VIS-FIR light wave range, which radiation is generated by emitter 3, after which the hydrogen liberated from the liquid is transferred through vent 7 outside reaction tank 1.1.

As a result of illuminating the surface of the liquid with suspension 2 of graphene particles in the liquid with electromagnetic radiation, electrons e−, which interact with the liquid molecules in the layer surrounding the graphene particles, are emitted from their surface. The emission of electrons from the surface of graphene caused by interaction with light occurs because of the photoelectric effect [A. Einstein, Ann. d. Phys. 17, 132 (1905)], where the kinetic energy of electrons Ekin=ℏω−ϕ, with ϕ as the work function of the electron to remove it from the graphene surface. Electrons e− (so-called hot electrons) emitted from the graphene surface react with molecules of the liquid leading to its ionization and fragmentation.

In the case of a water molecule, a reaction with the release of a hydrogen molecular ion (1) and, subsequently, the synthesis of a hydrogen molecule (2) occurs:

H₂O+e−→½O₂+2H++2e− (1)

2H++2e−→H₂ (2)

In the case of alcohols (for example in methanol), having been generated as a result of electromagnetic radiation, the fast electron e−, released from the graphene surface, leads, as a result of ionization, to the production of a molecular ion and its fragmentation, and then to the synthesis of a hydrogen molecule (3)

CH₃OH+e−→CH₃OH−−+2e−→CHO++H₂ (3)

The hydrogen molecule dissolves in water, where it gradually moves to the top surface of the liquid and can be liberated as gas as long as the concentration of the gas exceeds its acceptable solubility.

A schematic diagram of hydrogen synthesis is shown in FIG. 1.

The amount of the hydrogen produced from the reaction suspension depends on the intensity of illumination, the concentration of graphene particles and the liquid type, in such a way that the amount of generated hydrogen is higher the higher the intensity of illumination and the higher the concentration of graphene (wherein the limit value is the amount of graphene unable to form a suspension in the liquid with graphene particles falling to the bottom).

The rate of hydrogen liberation depends on the power of the light source, the greater the power of the light source, the greater the amount of the hydrogen generated per time unit, on exposure time, on the concentration of graphene particles in the liquid and a liquid volume to capsule volume ratio.

In the method according to the invention, the liquid is deionized water or alcohol or a mixture thereof in any proportion, preferably, in the method according to the invention, the alcohol that mixes well with water is used, such as methanol or ethanol, or propanol, or isopropanol, or mixtures thereof.

In the method according to the invention, the graphene particles suspended in the liquid are in the form of graphene oxide powder, porous graphene or graphene flakes of sizes from 0.1 to 100 μm.

According to the method of the present invention, suspension 2 of graphene particles in the liquid can be provided to tank 1.1 either in a continuous mode or periodically.

Preferably, in the method of the invention, emitter 3 operates in a continuous or pulsed mode, emitting electromagnetic waves with a wavelength in the range of 400-1100 nm, preferably 650-1100 nm.

In the method of the invention, during illumination, i.e. exposition of the contents of tank 1.1 to an electromagnetic radiation beam, the contents of tank 1.1 are also intensely mixed with the use of ultrasounds in a continuous or pulsed manner.

The object of the invention is also a device for implementing the method of the invention, characterized in that it has tank 1.1 equipped with vent 7 constituting a hydrogen collection system and has an electromagnetic radiation generation system consisting of optical system 1.3 and emitter 1.4 focusing the electromagnetic radiation beam, wherein emitter 1.4 is optionally equipped with power supply system 3 and control system 4.

The device of the invention has tank 1.1 in the form of a single vessel or an arrangement of vessels and, optionally, system 6a for mixing the contents of tank 1.1.

In the device of the invention, tank 1.1 is made of material partially or completely transmittable for the UV-VIS-FIR light wave range, such as glass, quartz, plastic or metal, the metal tank comprising at least one optical window made of material completely transmittable for the UV-VIS-FIR light wave range, such as glass, quartz, plastic. Tank 1.1 may be of any shape, preferably with a large surface area designed for illumination and transferring hydrogen over the liquid surface.

In a variant of the invention as shown in FIG. 2, the method of the invention is implemented in such a way that a liquid (water and/or alcohol) and a given form of graphene, preferably in the form of flakes, are placed in tight vessel (capsule) 1. Owing to hydrophobic properties of graphene in flakes, and a graphene mass to liquid mass ratio, the entire volume of the liquid in the vessel is filled with the graphene flakes. In this way, graphene suspension 2 is formed in the liquid. As light source 3, luminescent diodes embedded in optically transparent silicone 4, diodes attached to heat sink 5 to obtain its stable operation and the highest conductivity current, can be used. LED 3 may consist of LED arrays (e.g., 3×3, 10×10, and more) to increase the light-emitting surface. Preferably, capsule 1 does not contact the light emitter and is at a distance of d>0.2 mm. In the tight chamber, the concentration of hydrogen in space 6 above the liquid surface increases, the hydrogen produced is transferred through outlet/vent 7. Spent liquid is filled through valve 8 connected to supply system 9.

A vessel of partially or completely transparent material (glass, quartz, transparent plastic) transmittable for the UV-VIS-FIR light wave range with the liquid may be of any shape, preferably with a large surface area intended for illumination and transferring hydrogen above the liquid surface. Hydrogen production rate can be controlled by changing illumination density, illumination time, modulation in time (continuous or pulse illumination).

As a source of light in the case of devices for producing hydrogen in external, removable capsules, or in hydrogen production devices with a built-in capsule, the use of LEDs, laser diodes, or lasers operating in a continuous or pulsed regime, and other light sources, e.g. halogen lamps, xenon lamps, is preferred. In particular, in autonomous hydrogen production devices based on tanks adapted to operate in combined groups with a long-lasting process of hydrogen accumulation.

Solar radiation, preferably focused with the use of mirrors or lenses, can be used as the light source.

It is preferred that the surface of the liquid (water and/or alcohol or a mixture thereof containing graphene powder) in the vessel is illuminated.

Preferably, the liquid is illuminated with a focused laser beam.

Preferably, the liquid is illuminated with several laser beams or luminescent diodes.

It is also preferred that ultrasounds are used in the phase of producing the graphene and liquid suspension, to obtain high homogenization of the suspension, to accelerate the process of hydrogen emission from the liquid.

The solution according to the invention can be used as a hydrogen generator in systems for supplying hydrogen cells, filling hydrogen tanks with hydrogen, saturating fuel liquids with hydrogen, in chemical synthesis reactors, in hydrogen fuel-based electromobility, in medicine and agriculture.

### BRIEF DESCRIPTION OF THE DRAWINGS

The object of the invention in the embodiments is illustrated in the drawing, in which:

FIG. 1 shows a schematic diagram of a method for producing hydrogen with the method according to the invention, a list of designations: 1.1—tank, 1.2—suspension of graphene particles in the liquid, 1.3—optical system, 1.4—electromagnetic radiation emitter—A: 1.5—light-emitting diodes, lasers, 1.6—power supply, B: 1.7—sunlight, arrows show the direction of electromagnetic radiation emission;

FIG. 2 shows a schematic diagram of a vessel with a graphene solution, a list of designations: 1—vessel (body, panel), 2—suspension of graphene in the liquid, 3— light emitter in the form of LED (LED array), 4—transparent silicone for hermetic protection of LEDs, 5—heat sink, 6—space above the liquid surface, 7—vent (hydrogen collection system), 8—liquid filling valve, 9—liquid supply system;

FIG. 3 shows a vertical cross-sectional view of a device for producing hydrogen in capsules containing a liquid and graphene mixture based on LED with bottom emission, a list of designations: 1—vessel, 2—suspension of graphene in the liquid, 3—light emitter in the form of LED (LED array), 4—transparent silicone for hermetic protection of LEDs, 5—heat sink, 6—space above the liquid surface, 7—vent (hydrogen collection system), 8—liquid filling valve, 9—liquid supply system, 10—body, 11—power supply, 12—controller (current controller), 13—chamber;

FIG. 4 shows a vertical cross-sectional view of a device for producing hydrogen in capsules containing a liquid and graphene mixture based on laser diodes with emission to a side wall, a list of designations;

FIG. 5 shows a vertical cross-sectional view of a device for producing hydrogen in containers containing a liquid and graphene mixture based on laser diodes with emission at the suspension surface;

FIG. 6 shows a vertical cross-sectional view of a device for producing hydrogen in capsules containing a liquid and graphene mixture based on a halogen light bulb with a reflector with emission to a side wall;

FIG. 7 shows a cross-sectional view of a device for producing hydrogen in capsules containing a liquid and graphene mixture based on a halogen light bulb with a reflector with emission at the suspension surface;

FIG. 8 shows a cross-sectional view of a device for producing hydrogen in capsules containing a liquid and graphene mixture with a laser connected with the use of optical fiber;

FIG. 9 shows a cross-sectional view of a device for producing hydrogen by exposure to sunlight.

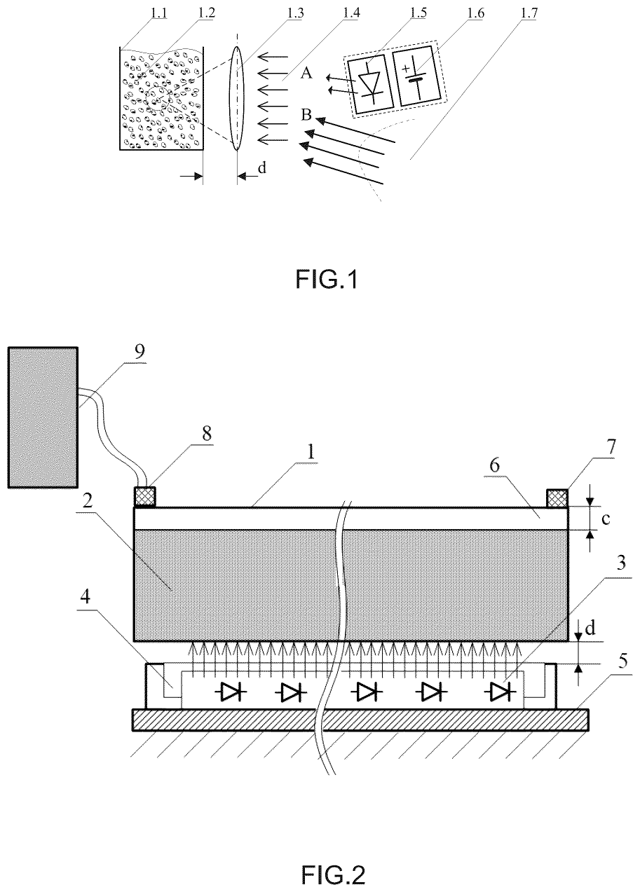

According to the invention, the device in its basic configuration has tank 1, graphene and liquid suspension 2, optical system 3 for focusing a light beam from emitter 4, which can be a LED or laser (FIG. 1 variant A), or solar light (FIG. 1 variant B). It is preferred that additional sub-assemblies associated with the reaction tank are added to the device configuration, as shown in FIG. 2.

### DETAILED DESCRIPTION OF THE INVENTION

### Description of Embodiments

The present invention is presented in more detail in an embodiment, which does not limit the scope thereof.

### EXAMPLES

### Example 1

Hydrogen generator—version with LEDs.

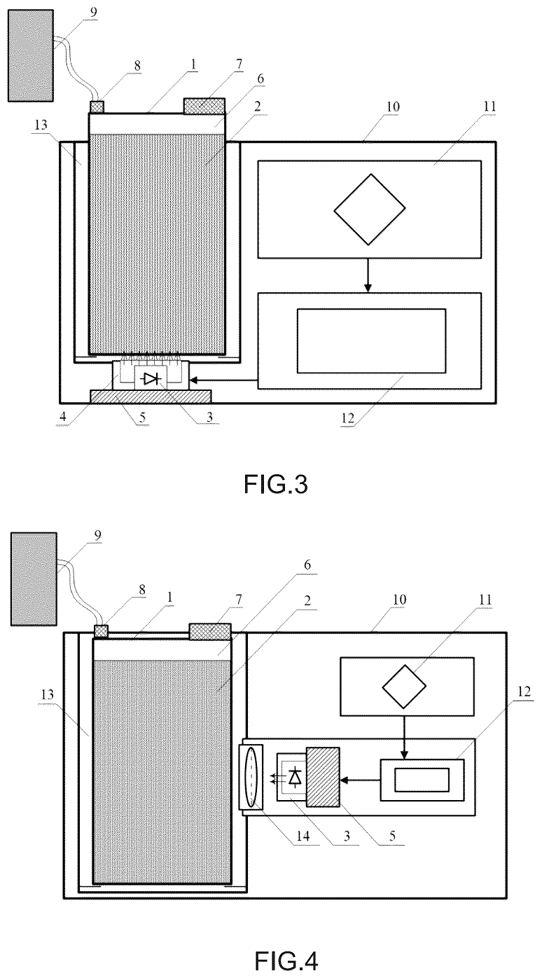

The solutions known in the state of art are based on pressure tanks, supplied directly from a hydrogen tank, or from a hydrogen generator/electrolyzer. The solution according to the invention shown in FIG. 2 can be integrated within one system with replaceable capsules/tanks (tank system) as shown in FIG. 3, using LED illumination.

Capsule 1 with suspension 2 is placed inside (in the body of) device 10 containing elements necessary for the hydrogen production process. Preferably, the device comprises power supply 11 together with controller 12, which in its simplest version is a current (current time profile) regulator of LED 3 as the source of light initiating hydrogen formation. Preferably, LED 3 with heat sink 5 is placed, by means of mounting elements in chamber 13, so as to illuminate the bottom of capsule 1. The capsule is in cavity (chamber) 13 of the device ensuring its stable position. The hydrogen produced is transferred through outlet/vent (hydrogen collection system) 7. Spent liquid is filled through valve 8 connected to supply system 9.

The device can operate in the position as in FIG. 3, as well as in the position in which the device is rotated by 90° in any direction. Effective operation is impossible when the device is rotated by 180°. Controller 4 may have suitable acceleration sensors to provide information about the orientation of the device.

### Example 2

Hydrogen generator—version with a laser.

The solution shown in FIG. 2 can be integrated within one system with replaceable capsules/tanks (tank system), as shown in FIG. 3, using laser diode illumination.

Capsule 1 with suspension 2 is placed inside (in the body of) device 10 containing elements necessary for the hydrogen production process. Preferably, the device comprises power supply 11 and controller 12, which may be placed inside an instrument with laser diode 3, the outgoing laser beam of which is focused on a side wall of capsule 1 with the use of optical system 14 (e.g., a collimator). Controller 12 in its simplest version is a regulator of current of the laser diode (laser diode current time profile), which diode is the source of light initiating hydrogen formation (FIG. 4). The capsule is in cavity (chamber) 13 of the device ensuring its stable position. Preferably, laser diode 3 is placed, by means of mounting elements of chamber 13, so as to illuminate a side wall of capsule 1. The hydrogen produced is transferred through outlet/vent (hydrogen collection system) 7.

The device can operate in the position as in FIG. 4, and its mirror reflection, as well as in the position in which the device is rotated by 90° clockwise. Then the laser beam illuminates the bottom of capsule 1.

Effective operation of the device is impossible when the device is rotated by 90° anticlockwise. Whereas the device cannot be rotated by 180° due to the problem with collecting the hydrogen produced (FIG. 1 element 7). Controller 12 may have suitable acceleration sensors to provide information about the orientation of the device.

### Example 3

Hydrogen generator—a version with a laser with emission at the suspension surface.

Capsule 1 with suspension 2 is placed inside (in the body of) device 10 containing elements necessary for the hydrogen production process. Preferably, the device comprises power supply 11 and controller 12, which may be placed inside an instrument with laser diode 3, the outgoing laser beam of which is focused on a side wall of the capsule, right at the suspension surface, with the use of optical system 14 (e.g., a collimator). Preferably, the laser is applied only to the surface of the suspension, without applying the laser deep into the suspension. Controller 12 in its simplest version is a regulator of the current of the laser diode (laser diode current time profile), which diode is the source of light initiating hydrogen formation. The capsule is in cavity (chamber) 13 of the device ensuring its stable position. Preferably, laser diode 3 is placed, by means of mounting elements of chamber 13, so as to illuminate only the surface of the suspension in capsule 1. The hydrogen produced is transferred through outlet/vent (hydrogen collection system) 7.

The device can operate in the position as in FIG. 5 and in its mirror reflection. Effective operation of the device is impossible when the device is rotated by 90° in any direction, and by 180°. Controller 4 may have suitable acceleration sensors to provide information about the orientation of the device.

### Example 4

Hydrogen generator—a version with a halogen light bulb and a reflector.

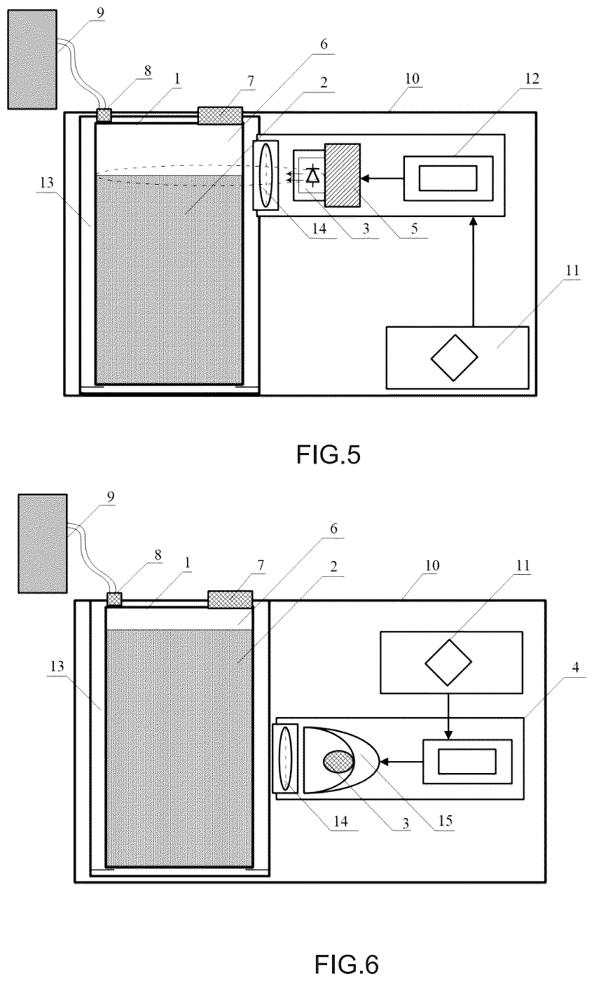

The solution in FIG. 2 can be integrated within one system with replaceable capsules/tanks (tank system) shown in FIG. 6 using illumination with halogen light bulbs with an optical system and a reflector.

Capsule 1 with suspension 2 is placed inside (in the body of) device 10 containing elements necessary for the hydrogen production process. Preferably, the device comprises power supply 11 and controller 12, which may be placed inside an instrument with halogen light bulb 3, the outgoing white light beam of which is focused on a side wall of capsule 1 with the use of optical system 14 (e.g., a focusing lens). Controller 12 in its simplest version is a light bulb switch. Preferably, the controller comprises a regulator of electric power (time profile of the current flowing through the bulb), which is the source of light initiating hydrogen formation. The capsule is in cavity (chamber) 13 of the device ensuring its stable position. Preferably, halogen light bulb 3 comprises reflector 15 and is placed, by means of mounting elements in chamber 13, so as to illuminate a side wall of capsule 1. The hydrogen produced is transferred through outlet/vent (hydrogen collection system) 7.

The device can operate in the position as shown in FIG. 6, and in its mirror reflection, as well as in the position in which the device is rotated by 90° clockwise. Effective operation of the device is impossible when the device is rotated by 90° anticlockwise. However, the device cannot be rotated 180° due to the problem with collecting the hydrogen produced (FIG. 1 element 7). Controller 12 may have suitable acceleration sensors to provide information about the orientation of the device.

### Example 5

Hydrogen generator—a version with a halogen light bulb with a reflector and emission at the suspension surface.

Capsule 1 with suspension 2 is placed inside (in the body of) device 10 containing elements necessary for the hydrogen production process. Preferably, the device comprises power supply 11 and controller 12, which may be placed inside an instrument with halogen light bulb 3, the outgoing white light beam of which is focused on a side wall of the capsule, right at the suspension surface, with the use of optical system 14 (e.g., a focusing lens). Preferably, light is applied only to the suspension surface, or at the suspension surface, of capsule 1 with the use of optical system 14 (e.g., a focusing lens). Controller 12 in its simplest version is a light bulb switch. Preferably, the controller comprises a regulator of electric power (time profile of the current flowing through the bulb), which is the source of light initiating hydrogen formation. The capsule is in cavity (chamber) 13 of the device ensuring its stable position. Preferably, halogen light bulb 3 comprises reflector 15 and is placed, by means of mounting elements of chamber 13, so as to illuminate exclusively the suspension surface. The hydrogen produced is transferred through outlet/vent (hydrogen collection system) 7.

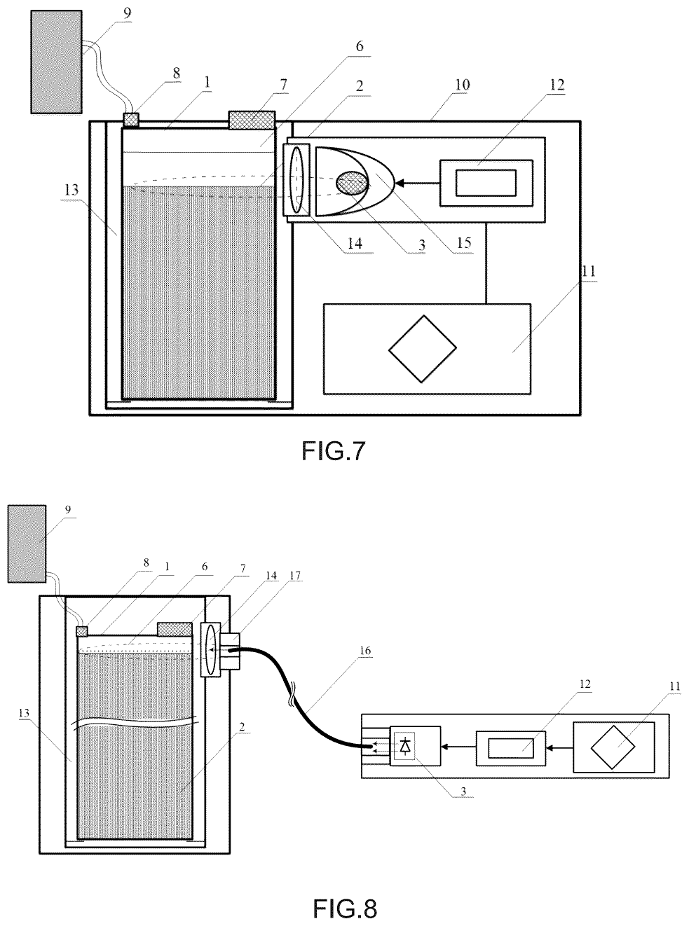

The device can operate in the position as shown in FIG. 7 and in its mirror reflection. Effective operation of the device is impossible when the device is rotated by in any direction, and by 180°. Controller 12 may have suitable acceleration sensors to provide information about the orientation of the device.

### Example 6

Hydrogen generator—a version with a laser diode and optic fiber with emission at the suspension surface.

The solution in FIG. 2 can be integrated within a system with replaceable capsules/tanks (tank system) to which light energy, necessary to produce hydrogen, is supplied, with the use of optical fiber connected to a laser diode with a heat sink as shown in FIG. 8.

Capsule 1 with suspension 2 is placed inside (in the body of) device 10 containing elements necessary for the hydrogen production process. Preferably, the device comprises power supply 11 and controller 12, which may be placed inside an instrument with a laser diode with a heat sink and optical fiber connection. The laser beam from optical fiber 16, through optical fiber bushing 17 and final optical system 14, is focused right at the suspension surface. Preferably, the laser beam is applied only to the suspension surface, without applying the laser deep into the suspension. Controller 4 in its simplest version is a regulator of the current of the laser diode (laser diode current time profile), which diode is the source of light initiating hydrogen formation. The capsule is in cavity (chamber) 13 of the device ensuring its stable position. Preferably, laser diode 3 is placed, by means of mounting elements of chamber 13, so as to illuminate exclusively the suspension surface. The hydrogen produced is transferred through outlet/vent (hydrogen collection system) 7.

### Example 7

Device for producing hydrogen by exposing the graphene and liquid suspension to sunlight.

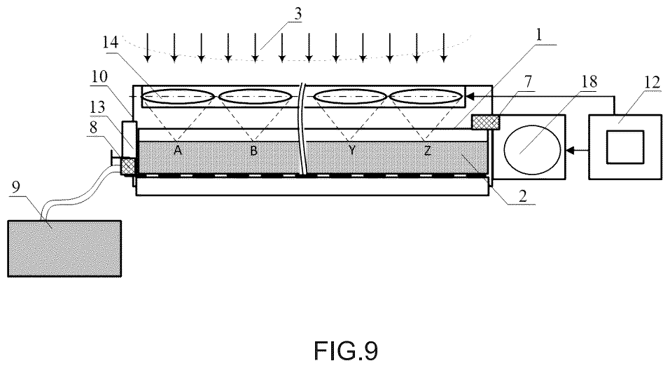

A device for producing hydrogen by illuminating a graphene-containing liquid with sunlight is shown in FIG. 9. The tank (panel) with liquid and graphene suspension 1 is placed inside (in the body of) device 2 containing elements necessary for the hydrogen production process. A beam of light with the characteristics of solar light 3 falls on the elements of the device, which is also capable to supply control systems 4 with the use of this radiation. Preferably, the device comprises controller 4, monitoring the hydrogen production process, and regulating the efficiency of the setting of optical instruments 5, comprising a system of mirrors which are capable of creating hydrogen formation initiation points (A-Z) on the surface of the graphene and liquid suspension, as shown in FIG. 8. The tank (panel) with the suspension can be replaceable owing to the mechanism for mounting it inside the device. The hydrogen produced gets, through hydrogen collection system 7, under suitable pressure, to tank 7a. Preferably, suspension mixing system 6a is used in tank 1 to prevent the hydrogen produced from accumulating in the graphene.

The use of mixing systems can accelerate hydrogen production several times, compared to the version of the device without them.

1. The method for producing hydrogen in a liquid characterized in that a suspension (2) of graphene particles in the liquid is provided to a reaction tank (1.1) made of transparent material partially or completely transmittable for the UV-VIS-FIR light wave range, and then the contents of the reaction tank (1.1) are exposed to an electromagnetic radiation beam with a wavelength in the UV-VIS-FIR light wave range, which radiation is generated by an emitter (3), after which the hydrogen liberated from the liquid is transferred through the vent (7) outside the reaction tank (1.1).

2. The method of claim 1, characterized in that the liquid is deionized water or alcohol or a mixture thereof in any proportions, preferably alcohol is methanol or ethanol, or propanol, or isopropanol, or mixtures thereof.

3. The method of claim 1, characterized in that the graphene particles suspended in the liquid are in the form of graphene oxide powder, porous graphene or graphene flakes of sizes from 0.1 to 100 μm.

4. The method of claim 1, characterized in that the emitter (3) operates in a continuous or pulsed mode, emitting electromagnetic waves with a wavelength in the range of 400-1100 nm, preferably 650-1100 nm.

5. The method of claim 1, characterized in that, during illumination, the contents of the tank (1.1) are intensely mixed with the use of ultrasounds in a continuous or pulsed manner.

6. A device for implementing the method of claim 1, characterized in that it has a tank (1.1) equipped with a vent (7) constituting a hydrogen collection system and an electromagnetic radiation generation system consisting of an optical system (1.3) and an emitter (1.4) focusing an electromagnetic radiation beam, wherein the emitter (1.4) is optionally equipped with a power supply system (3) and a control system (4).

7. The device of claim 6, characterized in that it has a tank (1.1) in the form of a single vessel or an arrangement of vessels and, optionally, a system (6a) for mixing the contents of the tank (1.1).

8. The device of claim 6, characterized in that the tank (1.1) is made of material partially or completely transmittable for the UV-VIS-FIR light wave range, such as glass, quartz, plastic or metal, a metal tank comprising at least one optical window made of material completely transmittable for UV-VIS-FIR light wave range, such as glass, quartz, plastic.
